(19) United States
(12) Patent Application Publication
(10) Pub. No.: US 2022/0315061 A1
(43) Pub. Date: Oct. 6, 2022

(54) VEHICLE CONTROL DEVICE, VEHICLE CONTROL METHOD, AND RECORDING MEDIUM

(71) Applicant: TOYOTA JIDOSHA KABUSHIKI KAISHA, Toyota-shi Aichi-ken (JP)

(72) Inventors: Marie Ishikawa, Nagoya-shi Aichi-ken (JP); Aya Hamajima, Nagoya-shi Aichi-ken (JP); Daichi Hotta, Minato-ku Tokyo (JP); Hayato Ito, Susono-shi Shizuoka-ken (JP); Hidekazu Sasaki, Yokohama-shi Kanagawa-ken (JP); Yasuhiro Kobatake, Nagoya-shi Aichi-ken (JP); Akihiro Kusumoto, Susono-shi Shizuoka-ken (JP)

(21) Appl. No.: 17/670,805

(22) Filed: Feb. 14, 2022

(30) Foreign Application Priority Data
Apr. 5, 2021 (JP) 2021-064356

(51) Int. Cl. B60W 60/00; G01C 21/36; B60Q 5/00

(52) U.S. Cl. CPC B60W 60/00253; G01C 21/3629; B60Q 5/00; B60W 2554/4029; B60W 2554/4044; B60W 2540/041

(57) ABSTRACT

A vehicle control device that is provided in a vehicle that runs autonomously includes a detection unit for detecting a rescue target person requiring rescue based on surrounding information of the vehicle acquired by the vehicle, and a vehicle control unit for controlling the vehicle. When the rescue target person is detected by the detection unit, the vehicle control unit performs evacuation control to stop the vehicle such that the rescue target person is able to evacuate from an outside of the vehicle into the vehicle.

### CROSS-REFERENCE TO RELATED APPLICATION

This application claims priority to Japanese Patent Application No. 2021-064356 filed on Apr. 5, 2021, incorporated herein by reference in its entirety.

### BACKGROUND

### 1. Technical Field

The present disclosure relates to a vehicle control device, a vehicle control method, and a recording medium.

### 2. Description of Related Art

Vehicles capable of autonomous running have been developed in recent years. Japanese Unexamined Patent Application Publication No. 2019-206300 (JP 2019-206300 A), in the vehicle capable of autonomous running, describes that the vehicle is moved to the evacuation site by autonomous running when a disaster occurs in order to ensure the safety of occupants of the vehicle.

### SUMMARY

However, a person requiring rescue is not limited to the occupant of the vehicle. For example, when there is an injured person on a road, it is desirable to quickly secure an evacuation site for the injured person.

Therefore, an object of the present disclosure is to provide an evacuation site for a person outside a vehicle requiring rescue using a vehicle capable of autonomous running.

The gist of the present disclosure is as follows.

(1) A vehicle control device provided in a vehicle that runs autonomously, the vehicle control device includes a detection unit for detecting a rescue target person requiring rescue based on surrounding information of the vehicle acquired by the vehicle, and a vehicle control unit for controlling the vehicle. When the rescue target person is detected by the detection unit, the vehicle control unit performs evacuation control to stop the vehicle such that the rescue target person is able to evacuate from an outside of the vehicle into the vehicle.

(2) The vehicle control device according to (1) further includes a guidance unit for guiding the rescue target person into the vehicle by at least one of sound information and visual information.

(3) In the vehicle control device according to (1) or (2), the vehicle control unit performs the evacuation control when a passenger is not present in the vehicle, and does not perform the evacuation control when a passenger is present in the vehicle.

(4) In the vehicle control device according to (1) or (2), an operation mode of the vehicle is switched between a passenger transport mode for transporting a passenger to a destination and an abnormality monitoring mode for monitoring presence or absence of an abnormality in the vicinity of the vehicle, and the vehicle control unit performs the evacuation control when the operation mode of the vehicle is the abnormality monitoring mode, and does not perform the evacuation control when the operation mode of the vehicle is the passenger transport mode.

(5) In the vehicle control device according to any one of (1) to (4), when the rescue target person is running away, the vehicle control unit predicts an escape route of the rescue target person in the evacuation control, and stops the vehicle at a position on the escape route ahead of the rescue target person.

(6) The vehicle control device according to any one of (1) to (5) further includes a warning unit for issuing a warning to the outside of the vehicle when the rescue target person is attacked by a suspicious person.

(7) A vehicle control method for controlling a vehicle that runs autonomously, the vehicle control method includes detecting a rescue target person requiring rescue based on surrounding information of the vehicle acquired by the vehicle, and when the rescue target person is detected, stopping the vehicle such that the rescue target person is able to evacuate from an outside of the vehicle into the vehicle.

(8) A recording medium on which a vehicle control computer program is recorded, the recording medium causing a computer to execute detecting a rescue target person requiring rescue based on surrounding information of a vehicle acquired by the vehicle that is able to run autonomously, and when the rescue target person is detected, stopping the vehicle such that the rescue target person is able to evacuate from an outside of the vehicle into the vehicle.

According to the present disclosure, a vehicle capable of autonomous running can be used to provide an evacuation site for a person outside the vehicle who needs rescue.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a vehicle according to a first embodiment of the present disclosure;

FIG. 2 is a diagram schematically showing a configuration of the vehicle of FIG. 1;

FIG. 3 is a functional block diagram of a processor of an electronic control unit (ECU) according to the first embodiment;

FIG. 4 is a flowchart showing a control routine executed by a vehicle control device according to the first embodiment of the present disclosure;

FIG. 5 is a flowchart showing a control routine executed by a vehicle control device according to a second embodiment of the present disclosure;

FIG. 6 is a flowchart showing a control routine executed by a vehicle control device according to a third embodiment of the present disclosure;

FIG. 7 is a functional block diagram of a processor of an ECU according to a fourth embodiment;

FIG. 8 is a diagram showing an example of a situation in which a rescue target person is running away;

FIG. 9A is a flowchart showing a control routine executed by a vehicle control device according to the fourth embodiment of the present disclosure; and

FIG. 9B is a flowchart showing a control routine executed by the vehicle control device according to the fourth embodiment of the present disclosure.

### DETAILED DESCRIPTION OF EMBODIMENTS

Hereinafter, embodiments of the present disclosure will be described with reference to the drawings. In the following description, similar components are denoted by the same reference numerals.

### First Embodiment

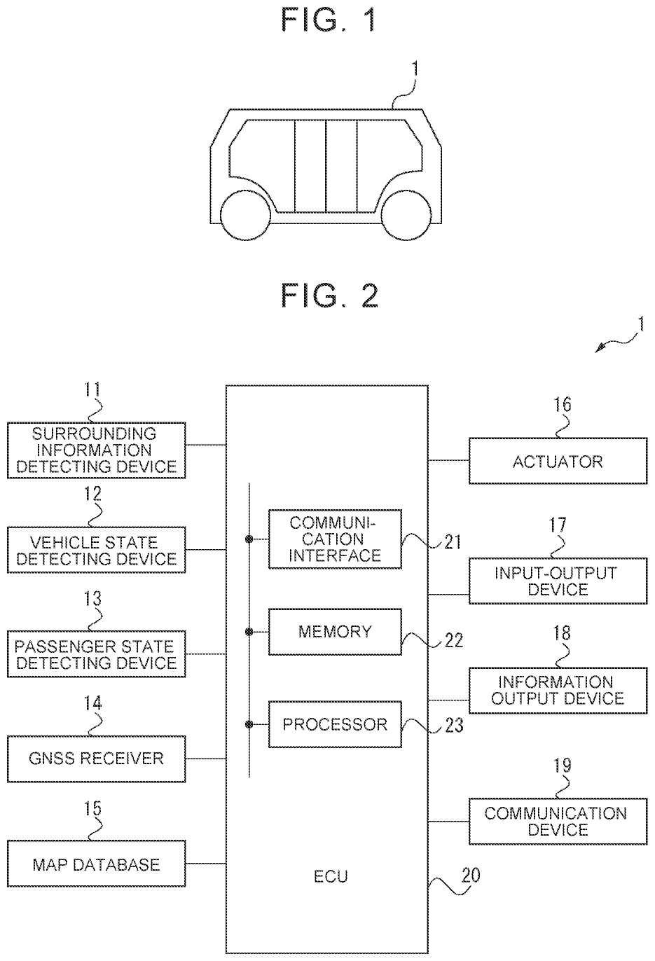

First, a first embodiment of the present disclosure will be described with reference to FIGS. 1 to 4. FIG. 1 schematically shows a vehicle 1 according to the first embodiment of the present disclosure. The vehicle 1 has a configuration to be described below, and is configured to run autonomously. That is, in the vehicle 1, all of acceleration, steering, and deceleration (braking) of the vehicle 1 is automatically controlled, and a driver for driving the vehicle 1 is not required. Autonomous running is also referred to as automatic driving, and the vehicle 1 is a so-called automatic driving vehicle.

Further, a plurality of seats is provided in the vehicle 1, and the vehicle 1 can transport a plurality of passengers by autonomous running. In the present embodiment, the vehicle 1 is a route bus in which an operation route of the vehicle 1 is determined in advance. That is, the vehicle 1 stops at each bus stop on the operation route such that the passengers board and alight the bus.

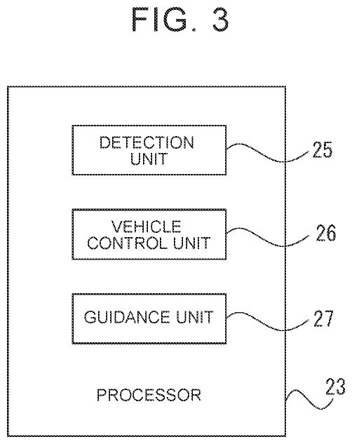

FIG. 2 is a diagram schematically showing a configuration of the vehicle 1 of FIG. 1. As shown in FIG. 2, the vehicle 1 includes an electronic control unit (ECU) 20. The ECU 20 includes a communication interface 21, a memory 22, and a processor 23, and executes various controls of the vehicle 1. The communication interface 21 and the memory 22 are connected to the processor 23 via a signal line. The ECU 20 is an example of a control device of the vehicle 1 provided in the vehicle 1. Although one ECU 20 is provided in the present embodiment, a plurality of the ECUs may be provided such that one of the ECUs corresponds to each function.

The communication interface 21 includes interface circuits for connecting the ECU 20 to an in-vehicle network conforming to standards such as Controller Area Network (CAN). The ECU 20 communicates with in-vehicle apparatuses connected to the in-vehicle network via the communication interface 21 and the in-vehicle network.

The memory 22 includes, for example, a volatile semiconductor memory (e.g., random access memory (RAM)) and a nonvolatile semiconductor memory (e.g., read-only memory (ROM)). The memory 22 stores computer programs executed by the processor 23, various data used when various processes are executed by the processor 23, and the like.

The processor 23 includes one or a plurality of central processing unit(s) (CPUs) and peripheral circuits thereof, and executes various processes. The processor 23 may further include other arithmetic circuits such as a logic-arithmetic unit, a numerical arithmetic unit, or a graphic processing unit.

Further, as shown in FIG. 2, the vehicle 1 includes a surrounding information detecting device 11, a vehicle state detecting device 12, a passenger state detecting device 13, a Global Navigation Satellite System (GNSS) receiver 14, a map database 15, an actuator 16, an input-output device 17, an information output device 18, and a communication device 19. Each of these in-vehicle apparatuses is electrically connected to the ECU 20.

The surrounding information detecting device 11 detects surrounding information of the vehicle 1. The surrounding information includes sound information around the vehicle 1, information of targets around the vehicle 1 (white lines of the road, other vehicles, pedestrians, bicycles, buildings, signs, traffic lights, obstacles, etc.). For example, the surrounding information detecting device 11 includes a microphone for receiving sound around the vehicle 1, an external camera for generating a surrounding image of the vehicle 1, a ranging sensor capable of detecting targets around the vehicle 1 (millimeter-wave radar, Laser Imaging Detection And Ranging (LIDAR), an ultrasonic sensor, or the like). The output of the surrounding information detecting device 11, that is, the surrounding information of the vehicle 1 detected by the surrounding information detecting device 11, is transmitted to the ECU 20 and input to the processor 23 of the ECU 20 via the input interface or the like of the ECU 20.

The vehicle state detecting device 12 detects the state amount of the vehicle 1. The state amount of the vehicle 1 includes a speed of the vehicle 1 (vehicle speed), acceleration, steering angle, yaw rate, and the like. The vehicle state detecting device 12 includes, for example, a vehicle speed sensor, an acceleration sensor, a steering angle sensor, a yaw rate sensor, and the like. The output of the vehicle state detecting device 12, that is, the state amount of the vehicle 1 detected by the vehicle state detecting device 12, is transmitted to the ECU 20 and input to the processor 23 of the ECU 20 via the input interface or the like of the ECU 20.

The passenger state detecting device 13 detects the state of the passenger of the vehicle 1. The passenger state detecting device 13 includes, for example, an in-vehicle camera, a seat belt sensor, a seating sensor, a human detecting sensor, and the like. The in-vehicle camera generates an image of an occupant. The seat belt sensor detects whether the seat belt is worn. The seating sensor detects whether the occupant is seated. The human detecting sensor detects boarding and alighting by the occupant. The output of the passenger state detecting device 13, that is, the passenger state of the vehicle 1 detected by the passenger state detecting device 13, is transmitted to the ECU 20 and input to the processor 23 of the ECU 20 via the input interface or the like of the ECU 20.

Based on the positioning information obtained from a plurality of positioning satellites (e.g., three or more), the GNSS receiver 14 detects the current position of the vehicle 1 (e.g., latitude and longitude of the vehicle 1). Specifically, the GNSS receiver 14 captures the positioning satellites and receives radio waves transmitted from the positioning satellites. Then, the GNSS receiver 14 calculates the distances to the positioning satellites based on the difference between the transmission time and the reception time of the radio wave, and detects the current position of the vehicle 1 based on the distances to the positioning satellites and the positions of the positioning satellites (orbital information). The output of the GNSS receiver 14, that is, the current position of the vehicle 1 detected by the GNSS receiver 14, is transmitted to the ECU 20 and input to the processor 23 of the ECU 20 via the input interface or the like of the ECU 20.

The GNSS is a generic term for satellite positioning systems such as Global Positioning System (GPS) by the United States, Global Navigation Satellite System (GLONASS) by Russia, Galileo by Europe, Quasi-Zenith Satellite System (QZSS) by Japan, BeiDou Navigation Satellite System (BeiDou) by China, and Indian Regional Navigation Satellite System (IRNSS) by India. Thus, the GNSS receiver 14 includes a GPS receiver.

The map database 15 stores three-dimensional map information such as road surface information, lane information, and building position information. The map stored in the map database 15 is a so-called high-precision map. The processor 23 of the ECU 20 acquires map information from the map database 15. The map information stored in the map database 15 may be periodically updated using communication with the outside of the vehicle 1, a Simultaneous Localization and Mapping (SLAM) technique, or the like. Further, the map database may be provided on a server outside the vehicle 1, and the processor 23 of the ECU 20 may acquire the map information from the server.

The actuator 16 operates the vehicle 1. For example, the actuator 16 includes a drive device for acceleration of the vehicle 1 (at least one of an engine and a motor), a brake actuator for deceleration (braking) of the vehicle 1, a steering motor for steering the vehicle 1, a door actuator for opening and closing a door of the vehicle 1, and the like. The processor 23 of the ECU 20 controls the actuator 16 such that the vehicle 1 runs autonomously.

The input-output device 17 is provided in the vehicle 1, and inputs and outputs information between the vehicle 1 and the passenger. The input-output device 17 includes, for example, a display for displaying information, a speaker for generating sound, an operation button or operation switch for the passenger to perform an input operation, a microphone for receiving the voice of the passenger, and the like. The input-output device 17 notifies the passenger of the vehicle 1 of various types of information output by the processor 23 of the ECU 20. In addition, the input-output device 17 transmits the information and the like input by the passenger to the processor 23 of the ECU 20. The input-output device 17 is also referred to as a Human Machine Interface (HMI). The passenger's portable terminal (e.g., a smart phone and a tablet terminal) may be connected to the in-vehicle network of the vehicle 1 wirelessly or by wire to function as an input-output device.

The information output device 18 is provided on the exterior or the like of the vehicle 1, and outputs information toward the outside of the vehicle 1. The information output device 18 includes, for example, a display for displaying information, a speaker for generating sound, and the like. The information output device 18 notifies a person outside the vehicle of various information output by the processor 23 of the ECU 20.

The communication device 19 is an apparatus (e.g., a data communication module (DCM)) that enables communication between the vehicle 1 and the outside of the vehicle 1. The communication device 19 is connected to the communication network via a radio base station by accessing a radio base station.

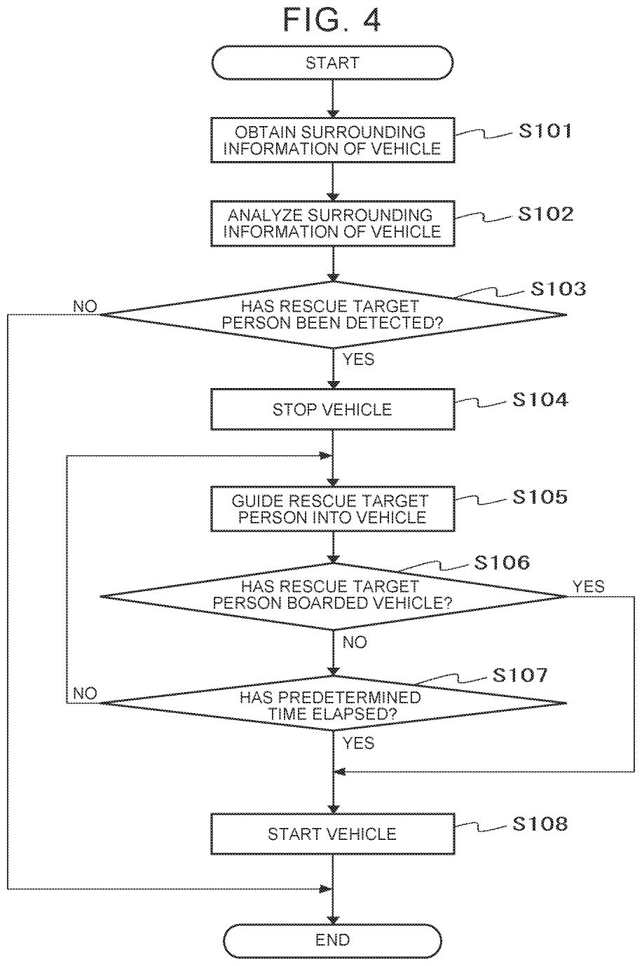

FIG. 3 is a functional diagram of the processor 23 of the ECU 20 according to the first embodiment. In the present embodiment, the processor 23 includes a detection unit 25, a vehicle control unit 26 and a guidance unit 27. The detection unit 25, the vehicle control unit 26, and the guidance unit 27 are functional modules realized by the processor 23 of the ECU 20 executing computer programs stored in the memory 22 of the ECU 20. Each of these functional modules may be realized by a dedicated arithmetic circuit provided in the processor 23.

As described above, the vehicle 1 transports passengers by autonomous running. In a case where a passenger gets sick in the vehicle 1, the vehicle 1 can move the sick passenger to an appropriate place. Examples of the appropriate place include the next bus stop, the nearest hospital, a location where the sick passenger is transferred to an ambulance.

However, the person requiring rescue is not limited to the passenger of the vehicle 1. For example, when there is an injured person on a road, it is desirable to quickly secure an evacuation site for the injured person. Therefore, in the present embodiment, the vehicle 1 is used to provide an evacuation site for a person outside the vehicle who needs rescue. Specifically, the following control is performed by the detection unit 25, the vehicle control unit 26, and the guidance unit 27.

Based on the surrounding information of the vehicle 1 acquired by the vehicle 1, the detection unit 25 detects a rescue target person requiring rescue. In the present embodiment, the detection unit 25 detects the rescue target person based on the surrounding information of the vehicle 1 detected by the surrounding information detecting device 11 provided in the vehicle 1. For example, by analyzing the surrounding image of the vehicle 1 generated by the external camera of the surrounding information detecting device 11 using an image recognition technique such as machine learning, the detection unit 25 detects the rescue target person in the vicinity of the vehicle 1.

Examples of the rescue target person include injured persons or emergency patients who have difficulty in walking, and persons who have been attacked by suspicious persons (thugs, thieves, stalkers, etc.). For example, when a person falling on the road, a person who receives violence, a person running away from someone, or the like is recognized from the surrounding image of the vehicle 1, the detection unit 25 determines that there is a rescue target person in the vicinity of the vehicle 1. In order to make this determination, learning of a machine learning model is performed in advance, and a large number of image data including a person in such a state is used as teacher data for learning.

In addition, when a gesture for which a person seeks help (e.g., shaking the hand largely) is recognized from the surrounding image of the vehicle 1, the detection unit 25 may determine that there is a rescue target person in the vicinity of the vehicle 1. In this case, in the learning of the machine learning model, a large number of image data including such a gesture are used as teacher data for learning.

In addition to or instead of the analysis of the surrounding image, the detection unit 25 may detect the rescue target person in the vicinity of the vehicle 1 by analyzing the sound information in the vicinity of the vehicle 1 detected by the microphone of the surrounding information detecting device 11 using a sound recognition technique such as machine learning. For example, when a voice or scream for seeking help is detected, the detection unit 25 determines that there is a rescue target person in the vicinity of the vehicle 1. In this case, in the learning of the machine learning model, a large number of pieces of voice data including such a voice are used as teacher data for learning.

When the rescue target person is detected by the detection unit 25, the vehicle control unit 26 performs evacuation control to stop the vehicle 1 such that the rescue target person can evacuate from the outside of the vehicle 1 into the vehicle 1. As a result, it is possible to provide an evacuation site to a person outside the vehicle who needs rescue by using the vehicle 1 capable of autonomous running.

The guidance unit 27 guides the rescue target person into the vehicle 1 by at least one of the sound information and the visual information. For example, via the information output device 18, by emitting a sound such as “evacuate into the vehicle” to the outside of the vehicle 1, the guidance unit 27 guides the rescue target person to the vehicle 1. Further, the guidance unit 27 may guide the rescue target person into the vehicle 1 by displaying characters or symbols indicating that the vehicle 1 is an evacuation site on the outside of the vehicle 1 via the information output device 18.

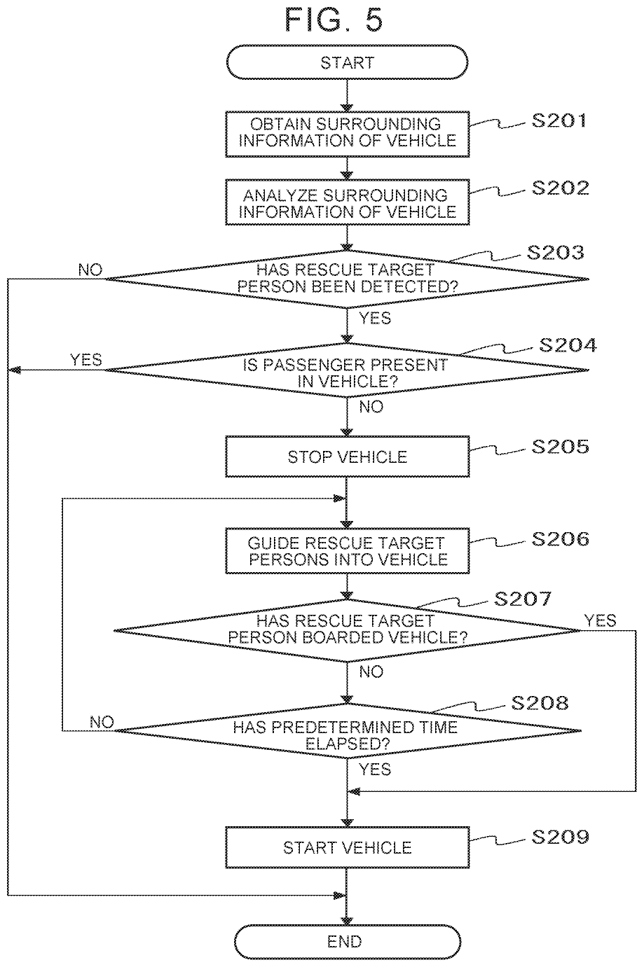

Hereinafter, the flow of the above-described control will be described with reference to FIG. 4. FIG. 4 is a flowchart showing a control routine executed by the vehicle control device according to the first embodiment of the present disclosure. This control routine is executed repeatedly by the ECU 20.

First, in step S101, the detection unit 25 acquires surrounding information of the vehicle 1 detected by the surrounding information detecting device 11. Next, in step S102, by analyzing surrounding information of the vehicle 1, for example, at least one of surrounding images of the vehicle 1 and sound information in the vicinity of the vehicle 1, the detection unit 25 detects a rescue target person in the vicinity of the vehicle 1.

Next, in step S103, the vehicle control unit 26 determines whether the rescue target person has been detected by the detection unit 25. When the detection unit 25 determines that the rescue target person is not detected, the control routine ends. On the other hand, when the detection unit 25 determines that the rescue target person has been detected, the control routine proceeds to step S104.

In step S104, the vehicle control unit 26 stops the vehicle 1 such that the rescue target person can evacuate from the outside of the vehicle 1 into the vehicle 1 using the actuator 16. That is, the vehicle control unit 26 performs evacuation control. For example, the vehicle control unit 26 specifies the position of the rescue target person based on the analysis result of the surrounding information of the vehicle 1, and stops the vehicle 1 on the shoulder near the rescue target person. When the position of the rescue target person is unclear, the vehicle control unit 26 may stop the vehicle 1 on the shoulder near the current position of the vehicle 1. Further, in the evacuation control, the vehicle control unit 26 may open the door of the vehicle 1 using the actuator 16 (specifically, the door actuator) after stopping the vehicle 1.

Next, in step S105, the guidance unit 27 guides the rescue target person into the vehicle 1 by providing at least one of the sound information and the visual information to the rescue target person via the information output device 18.

Next, in step S106, based on the output of the passenger state detecting device 13, the vehicle control unit 26 determines whether the rescue target person has boarded the vehicle 1. When it is determined that the rescue target person has boarded the vehicle 1, the control routine proceeds to step S108.

In step S108, the vehicle control unit 26 closes the door of the vehicle 1 to start the vehicle 1. For example, the vehicle control unit 26 moves the vehicle 1 toward the destination input by the rescue target person via the input-output device 17. The vehicle control unit 26 may present a plurality of candidate sites (a hospital, a police station, etc.) selected in advance as transportation destinations to the rescue target person via the input-output device 17, and move the vehicle 1 toward the candidate site selected by the rescue target person. Alternatively, the vehicle control unit 26 may communicate with a server outside the vehicle 1 via the communication device 19, and the server may notify the vehicle 1 of the transportation destination of the rescue target person. After step S108, the control routine ends.

On the other hand, when it is determined in step S106 that the rescue target person is not boarding the vehicle 1, the control routine proceeds to step S107. In step S107, the vehicle control unit 26 determines whether a predetermined time has elapsed since the vehicle 1 is stopped. When it is determined that the predetermined time has not elapsed, the control routine returns to step S105, and steps S105 and S106 are executed again.

On the other hand, when it is determined in step S107 that the predetermined time has elapsed, the control routine proceeds to step S108. In this case, since it is considered that the rescue target person does not need rescue, the vehicle control unit 26 closes the door of the vehicle 1 and causes the vehicle 1 to start. After step S108, the control routine ends.

### Second Embodiment

A vehicle control device according to the second embodiment is basically the same as the configuration and control of the vehicle control device according to the first embodiment, except the points described below. Therefore, the second embodiment of the present disclosure will be described below focusing on portions different from the first embodiment.

As described above, the vehicle 1 is used for transportation of passengers. Therefore, a rescue target person outside the vehicle may be detected when a passenger is present in the vehicle 1. When the evacuation control is performed in this case, there is a possibility that the schedule of the passenger in the vehicle 1 will be hindered.

Therefore, in the second embodiment, the vehicle control unit 26 performs evacuation control when a passenger is not present in the vehicle 1. The vehicle control unit 26 does not perform evacuation control when a passengers is present in the vehicle 1. This makes it possible to secure an evacuation site for the rescue target person without degrading the quality of the passenger transport service.

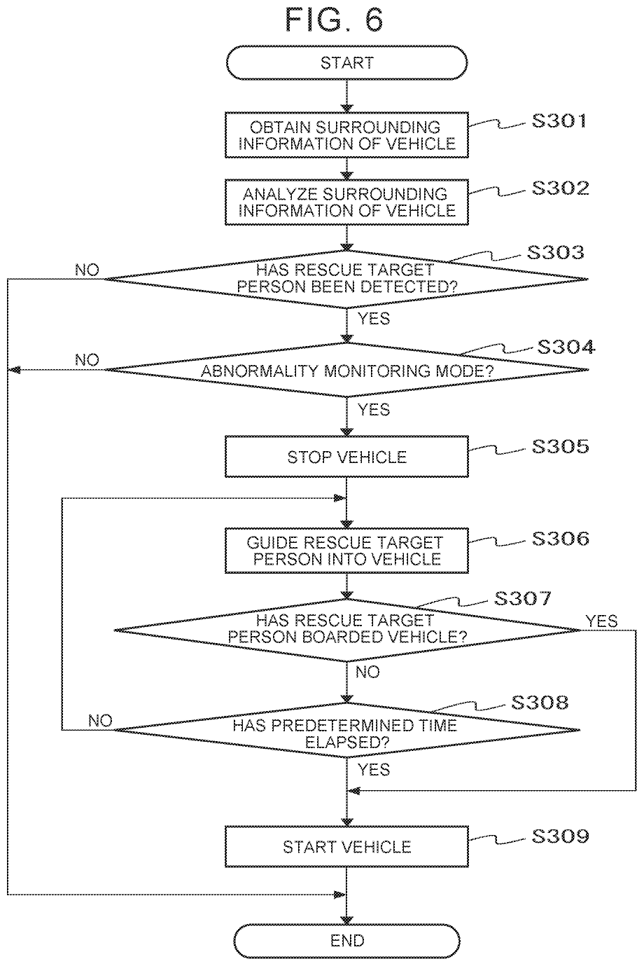

FIG. 5 is a flowchart showing a control routine executed by the vehicle control device according to the second embodiment of the present disclosure. This control routine is executed repeatedly by the ECU 20.

Steps S201 to S203 are executed in the same manner as steps S101 to S103 of FIG. 4. When it is determined in step S103 that the rescue target person has been detected, the control routine proceeds to step S204.

In step S204, the vehicle control unit 26, based on the output of the passenger state detecting device 13, determines whether a passenger is present in the vehicle 1. When it is determined that a passenger is present in the vehicle 1, the control routine ends. In this case, the detection unit 25 may transmit the information of the rescue target person together with the current position of the vehicle 1 to a server outside the vehicle 1. This makes it possible to dispatch other vehicles, such as emergency vehicles, for the rescue of the rescue target person.

On the other hand, when it is determined in step S204 that a passenger is not present in the vehicle 1, the control routine proceeds to step S205. In step S205, similarly to step S104 of FIG. 4, the vehicle control unit 26 stops the vehicle 1. After step S205, steps S206 to S209 are performed in the same manner as steps S105 to S108 of FIG. 4.

Note that step S204 may be performed prior to step S201. That is, the detection unit 25 may analyze the surrounding information of the vehicle 1 for detection of the rescue target person only when a passenger is not present in the vehicle 1.

### Third Embodiment

A vehicle control device according to a third embodiment is basically the same as the configuration and control of the vehicle control device according to the first embodiment, except the points described below. Therefore, the third embodiment of the present disclosure will be described below focusing on portions different from the first embodiment.

In the third embodiment, an operation mode of the vehicle 1 is switched between a passenger transport mode for transporting a passenger to a destination and an abnormality monitoring mode for monitoring presence or absence of an abnormality in the vicinity of the vehicle 1. When the vehicle 1 is a route bus, in the passenger transport mode, the vehicle 1 stops at each bus stop on the operation route such that the passenger board and alight the bus. That is, in the passenger transport mode, the passenger transport service is provided by the vehicle 1.

On the other hand, in the abnormality monitoring mode, the vehicle 1 runs on a predetermined running route without stopping at a predetermined boarding location. For example, in the abnormality monitoring mode, the surrounding information of the vehicle 1 detected by the surrounding information detecting device 11 is periodically transmitted from the vehicle 1 to a server outside the vehicle 1.

The operation mode of the vehicle 1 is switched between the passenger transport mode and the abnormality monitoring mode according to a predetermined condition (e.g., time zone, day of the week, etc.). For example, the operation mode of the vehicle 1 is set to the abnormality monitoring mode at night (for example, 10 p.m. to 6 a.m.). The operation mode of the vehicle 1 is set to the passenger transport mode in a time zone other than the night-time. The operation mode of the vehicle 1 may be set by the server for managing the operation of the vehicle 1 depending on the operation status, etc. of other vehicles.

When the operation mode of the vehicle 1 is the passenger transport mode and the evacuation control is performed, there is a possibility that the operation of the vehicle 1 will be hindered. Therefore, the vehicle control unit 26 performs evacuation control when the operation mode of the vehicle 1 is the abnormality monitoring mode. The vehicle control unit 26 does not perform the evacuation control when the operation mode of the vehicle 1 is the passenger transport mode. This makes it possible to secure an evacuation site for the rescue target person without degrading the quality of the passenger transport service.

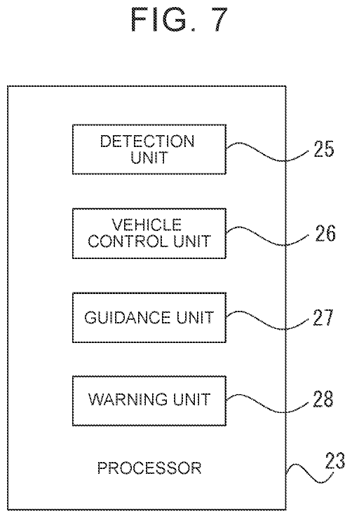

FIG. 6 is a flowchart showing a control routine executed by the vehicle control device according to the third embodiment of the present disclosure. This control routine is executed repeatedly by the ECU 20.

Steps S301 to S303 are executed in the same manner as steps S101 to S103 of FIG. 4. When it is determined in step S103 that the rescue target person has been detected, the control routine proceeds to step S304.

In step S304, the vehicle control unit 26 determines whether the operation mode of the vehicle 1 is an abnormality monitoring mode. When it is determined that the operation mode of the vehicle 1 is the passenger transport mode, the control routine ends. In this case, the detection unit 25 may transmit the information of the rescue target person together with the current position of the vehicle 1 to a server outside the vehicle 1. This makes it possible to dispatch other vehicles, such as emergency vehicles, for the rescue of the rescue target person.

On the other hand, when it is determined in step S304 that the operation mode of the vehicle 1 is the abnormality monitoring mode, the control routine proceeds to step S305. In step S305, similarly to step S104 of FIG. 4, the vehicle control unit 26 stops the vehicle 1. After step S305, steps S306 to S309 are performed in the same manner as steps S105 to S108 of FIG. 4.

Note that step S304 may be performed prior to step S301. That is, only when the operation mode of the vehicle 1 is the abnormality monitoring mode, for detection of the rescue target person, the detection unit 25 may analyze the surrounding information of the vehicle 1.

### Fourth Embodiment

A vehicle control device according to a fourth embodiment is basically the same as the configuration and control of the vehicle control device according to the first embodiment, except the points described below. Therefore, the fourth embodiment of the present disclosure will be described below focusing on portions different from the first embodiment.

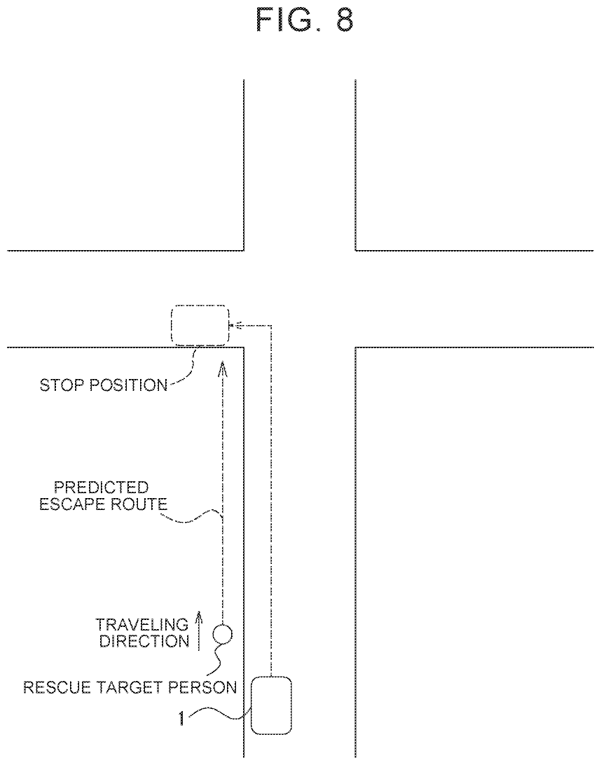

FIG. 7 is a functional diagram of the processor 23 of the ECU 20 according to the fourth embodiment. In the fourth embodiment, the processor 23 includes a warning unit 28 in addition to the detection unit 25, the vehicle control unit 26, and the guidance unit 27. The detection unit 25, the vehicle control unit 26, the guidance unit 27, and the warning unit 28 are functional modules realized by the processor 23 of the ECU 20 executing computer programs stored in the memory 22 of the ECU 20. Each of these functional modules may be realized by a dedicated arithmetic circuit provided in the processor 23.

As described above, the detection unit 25 detects a rescue target person requiring rescue. When the rescued target person is attacked by a suspicious person, it is desirable not only to provide the evacuation site to the rescue target person but also to deter the suspicious person from committing harmful acts. Therefore, in the fourth embodiment, the warning unit 28 issues a warning to the outside of the vehicle 1 when the rescue target person is attacked by the suspicious person. This makes it possible to deter the suspicious person from committing harmful acts and enables the rescue target persons to evacuate safely into the vehicle 1.

When the rescue target person is attacked by the suspicious person is when the rescue target person is subjected to violence, the rescue target person runs away, or the like. For example, via the information output device 18 or using the horn of the vehicle 1, the warning unit 28 emits a warning sound to the outside of the vehicle 1. The warning unit 28 may notify the outside of the vehicle 1 of a warning message such as “notify the police” via the information output device 18. The warning unit 28 may actually notify the police using the communication device 19. Also, by increasing the illumination of the headlight of the vehicle 1, the warning unit 28 may alert the outside of the vehicle 1.

In addition, in a case where the rescue target person runs away, even when the vehicle 1 is stopped in the vicinity of the rescue target person, it may be difficult for the rescue target person to evacuate into the vehicle 1. Therefore, in the fourth embodiment, when the rescue target person is running away, in the evacuation control, the vehicle control unit 26 predicts an escape route of the rescue target person, and stops the vehicle 1 at a position on the escape route ahead of the rescue target person. That is, the vehicle control unit 26 causes the vehicle 1 to reach the arrival point of the rescue target person preceding the rescue target person. This makes it possible for the rescue target person to smoothly evacuate to the inside of the vehicle 1.

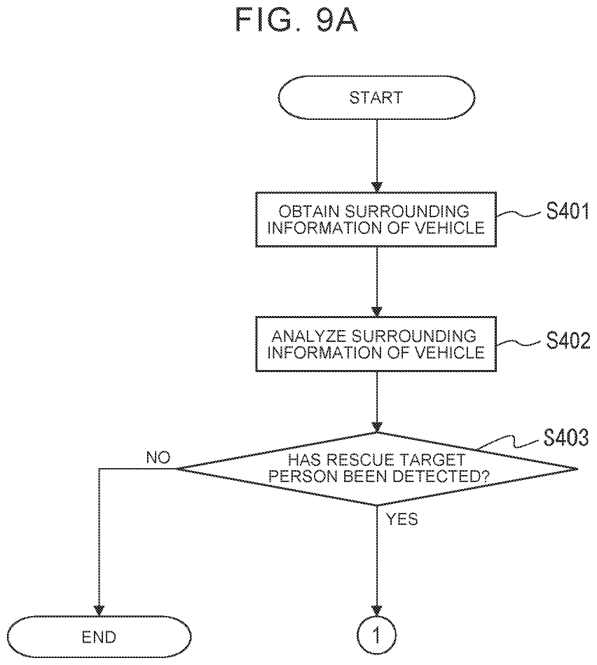

For example, the vehicle control unit 26 specifies a traveling direction of the rescue target person based on a series of time-series images of the rescue target person, and predicts that the straight traveling path in the traveling direction is the escape route of the rescue target person. In this case, in a situation as shown in FIG. 8, the vehicle control unit 26 stops the vehicle 1 at a position after the vehicle 1 turns left in the intersection ahead of the vehicle 1. In this case, the vehicle control unit 26 may stop the vehicle 1 preceding the intersection ahead of the vehicle 1.

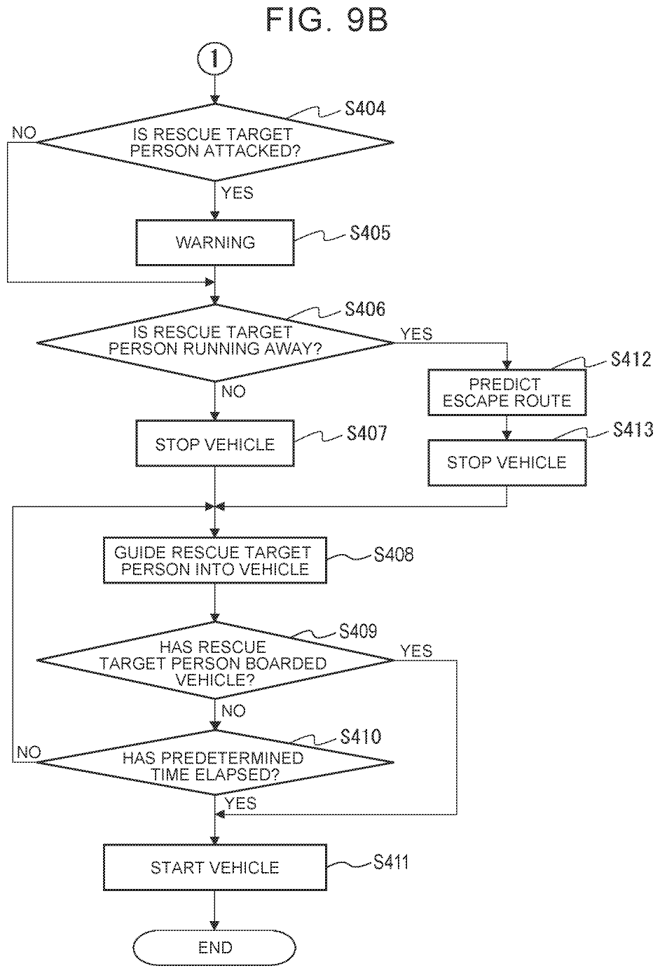

FIGS. 9A and 9B are each a flowchart showing a control routine executed by the vehicle control device according to the fourth embodiment of the present disclosure. This control routine is executed repeatedly by the ECU 20.

Steps S401 to S403 are executed in the same manner as steps S101 to S103 of FIG. 4. When it is determined in step S403 that the rescue target person has been detected, the control routine proceeds to step S404.

In step S404, the warning unit 28 determines whether the rescue target person is attacked by the suspicious person based on the analysis result of the surrounding information of the vehicle 1. When it is determined that the rescue target person is attacked by the suspicious person, the control routine proceeds to step S405.

In step S405, via the in-vehicle apparatus provided in the vehicle 1 (the information output device 18, the horn, the headlights, etc.), the warning unit 28 issues a warning to the outside of the vehicle 1. The warning unit 28 continues to warn until, for example, the vehicle 1 starts.

After step S405, the control routine proceeds to step S406. On the other hand, when it is determined in step S404 that the rescue target person is not attacked by the suspicious person, the control routine skips step S405 and proceeds to step S406.

In step S406, the vehicle control unit 26 determines whether the rescue target person is running away based on the analysis result of the surrounding information of the vehicle 1. When it is determined that the rescue target person does not run away, the control routine proceeds to step S407. In step S407, similarly to step S104 of FIG. 4, the vehicle control unit 26 stops the vehicle 1. After step S407, steps S408 to S411 are performed in the same manner as steps S105 to S108 of FIG. 4.

On the other hand, when it is determined in step S406 that the rescue target person is running away, the control routine proceeds to step S412. In step S412, the vehicle control unit 26 predicts the escape route of the rescue target person based on a series of time-series images of the rescue target person. The vehicle control unit 26 may predict the escape route of the rescue target person based on the course of the sidewalk in which the rescue target person is located, the lighting state of the traffic light positioned in front of the rescue target person, and the like.

Then, in step S413, the vehicle control unit 26 stops the vehicle 1 at a position on the escape route ahead of the rescue target person using the actuator 16. After step S413, steps S408 to S411 are performed in the same manner as steps S105 to S108 of FIG. 4.

### Other Embodiments

While embodiments according to the present disclosure have been described above, the present disclosure is not limited to these embodiments. The present disclosure is susceptible to various modifications and variations within the scope of the appended claims.

For example, when it is known that the vehicle 1 can be used as an evacuation site, the necessity of urging the rescue target person to evacuate to the inside of the vehicle 1 is low. Therefore, the information output device 18 and the guidance unit 27 may be omitted from the vehicle 1. Further, the vehicle 1 may be an automatic driving taxi, a demand type bus or the like to operate in accordance with a use request from a user.

A computer program that causes a computer to realize functions of each unit included in the processor 23 of the ECU 20 may be provided in a form stored in a computer-readable recording medium. The computer readable recording medium is, for example, a magnetic recording medium, an optical recording medium, or a semiconductor memory.

In addition, the above-described embodiments can be optionally combined and implemented. For example, when the second embodiment is combined with the fourth embodiment, step S204 of FIG. 5 is executed prior to step S406 in the control routines of FIGS. 9A and 9B. When the third embodiment is combined with the fourth embodiment, step S304 of FIG. 6 is executed prior to step S406 in the control routines of FIGS. 9A and 9B.

What is claimed is:

1. A vehicle control device provided in a vehicle that runs autonomously, the vehicle control device comprising:
a detection unit for detecting a rescue target person requiring rescue based on surrounding information of the vehicle acquired by the vehicle; and
a vehicle control unit for controlling the vehicle, wherein when the rescue target person is detected by the detection unit, the vehicle control unit performs evacuation control to stop the vehicle such that the rescue target person is able to evacuate from an outside of the vehicle into the vehicle.

2. The vehicle control device according to claim 1, further comprising a guidance unit for guiding the rescue target person into the vehicle by at least one of sound information and visual information.

3. The vehicle control device according to claim 1, wherein the vehicle control unit performs the evacuation control when a passenger is not present in the vehicle, and does not perform the evacuation control when a passenger is present in the vehicle.

4. The vehicle control device according to claim 1, wherein:
an operation mode of the vehicle is switched between a passenger transport mode for transporting a passenger to a destination and an abnormality monitoring mode for monitoring presence or absence of an abnormality in a vicinity of the vehicle; and
the vehicle control unit performs the evacuation control when the operation mode of the vehicle is the abnormality monitoring mode, and does not perform the evacuation control when the operation mode of the vehicle is the passenger transport mode.

5. The vehicle control device according to claim 1, wherein when the rescue target person is running away, the vehicle control unit predicts an escape route of the rescue target person in the evacuation control, and stops the vehicle at a position on the escape route ahead of the rescue target person.

6. The vehicle control device according to claim 1, further comprising a warning unit for issuing a warning to the outside of the vehicle when the rescue target person is attacked by a suspicious person.

7. A vehicle control method for controlling a vehicle that runs autonomously, the vehicle control method comprising:
detecting a rescue target person requiring rescue based on surrounding information of the vehicle acquired by the vehicle; and
when the rescue target person is detected, stopping the vehicle such that the rescue target person is able to evacuate from an outside of the vehicle into the vehicle.

8. A non-transitory recording medium on which a vehicle control computer program is recorded, the recording medium causing a computer to execute:
detecting a rescue target person requiring rescue based on surrounding information of a vehicle acquired by the vehicle that is able to run autonomously; and
when the rescue target person is detected, stopping the vehicle such that the rescue target person is able to evacuate from an outside of the vehicle into the vehicle.
